(19) United States
(12) Patent Application Publication
(10) Pub. No.: US 2001/0018082 A1
(43) Pub. Date: Aug. 30, 2001

(54) EFFERVESCENT CALCIUM SUPPLEMENTS

(75) Inventor: MARY MORA FOX, FAIRFIELD, OH (US)

Correspondence Address: JAMES F MCBRIDE, THE PROCTOR & GAMBLE COMPANY, WINTON HILL TECHNICAL CENTER, 6071 CENTER HILL AVENUE - BOX 331, CINCINNATI, OH, 45224

(73) Assignee: MARY M. FOX

(21) Appl. No.: 09/428,261

(22) Filed: Oct. 27, 1999

Related U.S. Application Data
(63) Continuation of application No. 07/906,638, filed on Jun. 30, 1992, now abandoned.

(51) Int. Cl. A23L 2/40

(52) U.S. Cl. 426/74; 426/591; 426/590

(57) ABSTRACT

This invention relates to effervescent compositions which provide calcium supplementation via a soluble calcium source.

### TECHNICAL FIELD

This invention relates to effervescent compositions which provide calcium supplementation via a soluble calcium source.

### BACKGROUND OF THE INVENTION

Vitamin and mineral supplements for human and veterinary use are commonplace. Some diets, heavy physical exercise and disease conditions may require the intake of considerable quantities of minerals and vitamins apart from those generally obtained through what otherwise would be considered a normal diet. Vitamin and mineral supplementation is important primarily for those who have inadequate diets, including growing children. Older adults have an additional need for calcium to help prevent age-related bone loss. In particular, postmenopausal women need additional calcium due to hormonal changes which can accelerate the bone loss rate leading to a further diminishment in bone mass. Therefore, supplementation of the diet with a highly bioavailable source of calcium is desirable.

Calcium can be obtained from a variety of dietary sources. The primary sources of calcium are dairy products, in particular milk. However, beginning in young adulthood and continuing through later life, milk is typically not consumed in sufficient quantities by the general population at levels sufficient to meet their dietary requirements. Diminished consumption can be caused by lactose intolerance as well as by the unattractiveness of milk as a drink for “social occasions”.

Many calcium-containing compounds and compositions have been described for use as nutritional supplements. Many commercial preparations are also available, typically containing calcium carbonate or calcium phosphate. Other calcium salts have also been described for use in calcium supplements, including calcium lactate, calcium citrate and calcium gluconate.

One of the problems with supplementation of the diet with calcium is that all sources of calcium are not equally soluble or bioavailable. Calcium citrate is poorly soluble in water; 1 gram of calcium citrate dissolves per 1050 grams of cold water. Calcium malate exhibits a similar solubility. Calcium hydroxide is only slightly soluble in water, and it absorbs carbon dioxide from the air readily forming calcium carbonate.

It is essential for dietary supplementation that the calcium salts be soluble in the stomach. This solubilization aids in making the calcium more readily available to the body. Thus the choice of calcium salts depends upon the interaction of the salts in acidic (stomach pH) solutions.

Another problem is taste. Calcium tends to be chalky in flavor. Chewable tablets are a popular form for calcium supplements. However, they leave a gritty mouthfeel and a chalky aftertaste which many find unpleasant. The calcium salts used in these tablets are typically calcium phosphate and calcium carbonate. The utility of these known supplements varies. Unlike agents (such as estrogen) which affect the metabolism of bone, calcium nutritional supplements have been thought to merely provide another source of the nutrient (which may or may not be properly absorbed and metabolized).

An alternative to chewable tablets which would be convenient and easy to swallow without a gritty mouthfeel or an unpleasant chalky aftertaste is needed. Such an alternative could supply a nutritionally-supplemental amount of bioavailable, soluble calcium in a form attractive to a large segment of the population. Such an alternate would be an effervescent beverage. Heretofore, it has been difficult to supplement beverages with more than 20% to 30% RDA of calcium (based per serving) without encountering precipitation problems and/or organoleptic problems. Therefore, 20% to 30% of RDA has been considered acceptable due to its equivalent to cow's milk in calcium value. It is an object of the present invention to provide for an effervescent beverage which provides a soluble bioavailable calcium.

Another object is to make an effervescent beverage which can stand before drinking, be stored for future drinking, or for finishing at a later time, and/or administration over a period of time, preferably 2 days, more preferably 4 days and most preferably 7 days. Thus constant mixing is not necessary to maintain all or at least 75% of the calcium in solution.

Not only does the present invention provide such alternatives, but in addition the beverage mix of this invention is pleasing to the eye and ear of the consumer by providing an effervescent effect when deposited in a liquid medium, usually water. Moreover, unlike other calcium sources it is readily soluble in water and provides a clear beverage.

These and other objectives are readily apparent from the description herein.

### BRIEF DESCRIPTION OF DRAWINGS

FIG. 1 of the present invention shows a comparison of soluble calcium fraction of seven samples of effervescent sachets or powders in 240 ml of water at 25° C. The comparison is illustrated in the form of a bar graph. The height of the vertical axis demonstrates the milligrams of calcium in solution. The bars demonstrate the amount of soluble calcium present at one hour, one day, four days, five days and seven days.

### SUMMARY OF THE INVENTION

The present invention relates to calcium supplements and to calcium supplemented beverages. The calcium supplements of the present invention employ mixtures of calcium salts, citric acid and malic acid to form calcium citrate malate in situ, the beverage/liquid medium. The tablets, capsules, granules and powders of the present invention provide an effervescent effect when deposited in liquid medium, preferably water. The compositions of the present invention are completely soluble in water thus providing a clear beverage without cloudiness or residue. Fruit juice or other acidic beverage is not required.

The compositions provide a method for significantly supple- menting calcium in a human or other animal subject by means of administering to said subject a safe and effective amount of calcium citrate malate, a soluble bioavailable calcium source. Over time, the present compositions provide for at least 75% of the soluble calcium to remain in solution after 2 days, preferably at least 85% after 2 days. The compositions comprise calcium salts, citric acid and malic acid wherein the percentage of citric acid to total acid(s) is at least 23% and not more than 75%, preferably at least 25% and not more than 70%, and the ratio of acid equivalents to base equivalents is from about 0.8 to about 1.8, preferably from about 1.0 to 1.6 and most preferably from about 1.3 to about 1.5. The primary calcium source is calcium carbonate. Secondary calcium sources can comprise up to about 30% of the soluble calcium ions. The compositions are substantially free of sodium and potassium carbonate and bicarbonate, preferably less than 5% of the composition. The compositions can provide any proportion or magnitude of the Recommended Dietary Allowance (RDA) for humans. Typically, this will be from about 10% to about 300% of RDA for humans. The compositions are administered in an oral dosage form.

All ratios, proportions and percentages herein are by weight, unless otherwise specified.

### DETAILED DESCRIPTION OF THE INVENTION

As used herein, the term “comprising” means various components can be conjointly employed in the supplements and beverages of the present invention. Accordingly, the terms “consisting essentially of” and “consisting of” are embodied in the term comprising.

By “nutritional” or “nutritionally-supplemental amount” herein is meant that the amount used in the practice of this invention provide a nourishing amount of calcium. This is supplemental or in addition to the amount found in the diet. Preferably, at least 30% of the RDA and more preferably from about 50% to 100% of RDA for any given individual will be provided. The RDA is as defined in The United States of America (see Recommended Daily Dietary Allowance-Food and Nutrition Board, National Academy of Sciences-National Research Council). The amount of RDA calcium differs for each individual depending on weight, age, sex and other factors. The present compositions can be formulated to provide for any proportion or magnitude of RDA calcium for any individual.

Specific compounds and compositions to be used in these processes must, accordingly, be edible and safe for human and animal consumption or pharmaceutically acceptable. As used herein, a “pharmaceutically acceptable” component is one that is suitable for use with humans and/or animals without undue adverse side effects (such as toxicity, irritation, and allergic response) commensurate with a reasonable benefit/risk ratio.

As used herein, the term “flavors” includes both fruit and botanical flavors.

As used herein the term “sweeteners” includes sugars, for example, glucose, sucrose, and fructose. Sugars also include high fructose corn syrup solids, liquid fructose, invert sugar, sugar alcohols, including sorbitol, and mixtures thereof. Artificial sweeteners are also included in the term sweetener.

As used herein the term “calcium citrate malate” refers to a mixture of calcium, citrate and malate ions or salts. The specific ratios will be defined as the ratio of calcium to citrate to malate ions. All ratios of calcium, citrate and malate are on a molar basis. “Calcium citrate malate” is referred to as “CCM”.

As used herein, the term “malic acid” refers to the mixture of the D and L isomers, i.e., malic acid is optically active and the racemic mixture is used herein. D-malic acid and L-malic acid can be used separately or as mixtures in the compositions of the present invention.

As used herein, the term “single strength beverage(s)” refers to a beverage composition in a ready-to-serve, drinkable form.

### Calcium Component

In supplements of the type disclosed herein, the nutritionally supplemental amount for calcium will generally comprise more than 10% of the RDA and up to 300% of the RDA. Preferably more than 50% RDA, most preferably from about 75% to about 100% of the RDA, per unit portion of the finished supplement will be present. Of course, it is recognized that the preferred daily intake of any mineral may vary with the user. In general, the RDA (calcium) will range from 360 mg per 6 Kg for infants to 800 mg/54-58 Kg female or male, depending somewhat on age.

The methods of this invention involve administration of CCM which is formed in situ, in the liquid medium, preferably water, by a calcium salt, or mixtures of calcium salts, and an acid component comprising citric acid and malic acid.

The primary calcium source for compositions of the present invention is calcium carbonate. These salts are neutralized My the acid component, hence forming water and carbon dioxide providing an effervescent effect. Highly solubilized systems can be obtained using less acid component by use of a secondary source of calcium in combination with the primary source. Suitable secondary sources of calcium include calcium lactate, calcium acetate, calcium oxide, calcium hydroxide, calcium sulfate, calcium chloride, calcium phosphate, calcium hydrogen phosphate and calcium dihydrogen phosphate, as well as the respective organic salts of calcium, e.g., calcium citrate, calcium malate, or calcium tartrate. Preferably, secondary sources are calcium salts of organic acids such as calcium fumarate, calcium tartrate, calcium malate, calcium acetate and calcium lactate. The preferred secondary sources of calcium are calcium lactate, calcium malate, and calcium acetate. When mixed in part with calcium carbonate, they still impart an effervescent effect. The secondary sources of calcium can provide no more than about 30% of the soluble calcium ion, preferably no more than about 23% of the soluble calcium ion and most preferably no more than about 20% of the soluble calcium ion. When utilizing secondary calcium sources, the weight ratio of acid equivalents to base equivalents is preferably from about 0.5 to about 1.8 and most preferably from about 0.8 to about 1.5.

To be useful in the present invention, the calcium needs to be “solubilized”, i.e., dissolved or suspended, in the liquid medium or beverage. Accordingly, the amount of calcium included in the effervescent compositions of the present invention will be referred to in terms of “solubilized calcium” or “soluble calcium ion”, i.e., the amount of calcium ion dissolved or suspended.

As the primary calcium source, calcium carbonate preferably provides 100%, preferably from about 70% to about 100% and more preferably from about 77% to about 100% of the soluble calcium. Suitable secondary calcium sources, preferably calcium lactate, calcium malate and calcium acetate, can provide up to about 30%, preferably up to about 23%, and more preferably up to about 20%, of the soluble calcium.

The effervescence or carbonation in these compositions is provided by the calcium carbonate. The present compositions are substantially free (less than 5%, preferably less than 3%) of sodium or potassium carbonate or bicarbonate.

### Acid Component

A key component of the present invention from the standpoint of stability against precipitation of insoluble calcium salts and taste is the edible acid component. This acid component comprises a mixture of citric acid and malic acid. These acids can be present as acids or else as their respective anionic salts, i.e., citrate and malate.

The CCM can contain other acid anions in addition to citrate and malate. Such anions can include, for example, acetate, lactate, carbonate, hydroxide, phosphate and mixtures thereof depending on the calcium source.

The edible acid component comprises a mixture of citric acid and malic acid wherein the percentage of citric acid to total acid(s) is at least about 23%, preferably at least about 25%, and not more than about 75%, preferably not more than about 70%. The percentage of citric acid to total acid(s), from acids added or present in the liquid medium, is calculated as:

x=grams citric acid

y=grams of malic acid

z=grams of other acid(s) added or present in liquid medium.

formula: x/(x+y+z).

The ratio of acid equivalents to base equivalents in the edible acid component is from about 0.8 to about 1.8, preferably from about 1.0 to about 1.6 and most preferably from about 1.3 to about 1.5. The rate of acid equivalents to base equivalents is calculated as:

$$Acid Equivalents / Base Equivalents ratio = \frac{[ 3 ( x / 192 ) + 2 ( y / 134 ) + A ( z / mw ) ]}{2 ( b / 40 )}$$

x=grams citric acid

y=grams of malic acid

z=grams of other acid(s) present in supplement or liquid medium

A=number of ionizable carboxylic acid or acid groups in acid(s)

b=grams of calcium

mw=molecular weight of acid z

The acids which can be used to provide acid equivalents are citric, malic, acetic, phosphoric and other organic or inorganic anions which are acid in aqueous solutions. An acid is defined as a species having a tendency to lose or to donate a proton, and a base is a species having the tendency to accept or add a proton. The acid equivalent value represents the number of protons that can be donated. For example, citric acid is a tri-carboxylic organic acid and can donate as many as three (3) protons. Therefore, citric acid's “acid equivalent” value is three (3). Conversely, CaCO₃ can accept as many as two (2) protons and its “base equivalent” value is two (2).

The effervescent reaction which occurs upon placing the supplement into a liquid medium can be carried out at an ambient (20° C.) reaction temperature or higher. These beverages may be stored at up to 25° C. for about 4 hours, preferably at least about 2 days, and more preferably at least about 4 days. Preferably, these beverages are refrigerated.

### Supplement Forms

The calcium and acid components which make up the present invention are in the form of powders. The supplement compositions of the present invention are preferably in the form of powders having a particle size of from about 50 microns to about 500 microns.

The supplements can be delivered in powder form, compressed into tablets, encapsulated, granulated or delivered in any acceptable form for oral dosage. Preferably, the powders are compressed into tablets. Tablets can optionally contain suitable binders, lubricants, diluents, disintegrating agents, coloring agents, flavoring agents, and melting agents.

These solid forms are prepared and their optional ingredients selected such that the compositions are deposited in 8 ounces (240 ml) of water, all solid matter is dissolved. Further, after at least about 2 days at 25° C. at least about 75% of the soluble calcium remains in solution and preferably 1 at least about 85% of the soluble calcium remains in solution and most preferably at least about 90% of the soluble calcium remains in solution. In general, the powder or tablet will be in range of 5 grams to 10 grams for use in 8 ounces (240 ml) of water.

### OPTIONAL INGREDIENTS

### Flavor Component

The flavor component of the present invention contains flavors selected from natural flavors, botanical flavors and mixtures thereof. The term “fruit flavors” refers to those flavors derived from the edible reproductive part of a seed plant, especially one having a sweet pulp associated with the seed. Also included within the term “fruit flavor” are synthetically prepared flavors made to simulate fruit flavors derived from natural sources.

The term “botanical flavor” refers to flavors derived from parts of a plant other than the fruit; i.e., derived from bean, nuts, bark, roots and leaves. Also included within the term “botanical flavor” are synthetically prepared flavors made to simulate botanical flavors derived from natural sources. Examples of such flavors include cocoa, chocolate, vanilla, coffee, cola, tea, and the like. Botanical flavors can be derived from natural sources such as essential oils and extracts, or can be synthetically prepared.

The particular amount of the flavor component effective for imparting flavor characteristics to the supplements and food or beverage mixes of the present invention (“flavor enhancing”) can depend upon the flavor(s) selected, the flavor impression desired, and the form of the flavor component. The flavor component can comprise at least about 0.001% by weight of the present compositions and preferably from about 0.05% to about 10% of the present compositions. For chocolate or cocoa, the amount of flavor can be from about 0.05% to about 20%. The determination of amount of flavor component to be added to the supplement is within the skill of one in the art and depends on the flavor intensity desire.

Supplements can be flavored with fruit or other botanical flavors, e.g., vanilla, strawberry, cherry, pineapple, banana, and mixtures thereof.

The supplement can be diluted with a fruit juice or a dilute fruit juice instead of water. The sugars present in the juice are useful sweeteners, and the juice can be the flavor component. Such beverages can contain from about 5% to about 100% juice. Preferably dilute juice beverages will have from about 10% to about 40% juice. Preferred juices are orange, cranberry, apple, pear, grape, raspberry, lemon, grapefruit, pineapple, banana, blackberry, blueberry and passion fruit juices and mixtures thereof.

### Sweetener

The sweetener composition is usually a monosaccharide or a disaccharide. These include sucrose, fructose, dextrose, maltose and lactose. Other carbohydrates can be used if less sweetness is desired. Mixtures of these sugars can be used.

The compositions of the present invention can contain natural sweeteners, artificial sweeteners and mixtures thereof. Suitable artificial sweeteners include saccharin, cyclamates, acesulfam, L-aspartyl-L-phenylalanine lower alkyl ester sweeteners (e.g., aspartame), L-aspartyl-D-serine amides disclosed in U.S. Pat. No. 4,411,925 to Brennan et al., issued Oct. 23, 1983, L-aspartyl-D-serine amides disclosed in U.S. Pat. No. 4,399,163 at Brennan et al., issued Aug. 16, 1983, L-aspartyl-L-1-hydroxymethyl-alkaneamide sweeteners disclosed in U.S. Pat. No. 4,338,346 to Brand, issued Dec. 21, 1982, L-aspartyl-1-hydroxyethyl-alkaneamide sweeteners disclosed in U.S. Pat. No. 4,423,029 to Rizzi, issued Dec. 27, 1983, L-aspartyl-D-phenylglycine ester and amide sweeteners disclosed in European Patent Application 168,112 to J. M. Janusz, published Jan. 15, 1986, and the like. A particularly preferred sweetener is aspartame.

The amount of the sweetener effective in the supplements of the invention depends upon the particular sweetener used and the sweetness intensity desired. For noncaloric sweeteners (artificial sweeteners), this amount varies depending upon the sweetness intensity of the particular sweetener. From about 0.01% to about 4% of a non-caloric sweetener is usually sufficient. The determination of the amount of sugar to be used is within capability of one skilled in the art. In determining the amount of sugar, any sugar or other sweetener present in the flavor component is also included. In the case of sugars, from about 1% to about 14% can be used typically. Low-calorie sweetener combinations containing a noncaloric sweetener such as aspartame and a sugar can also be used in the present compositions. Colored sugar crystals are preferred optional ingredients.

### Other Ingredients

Other minor ingredients are frequently included in supplements and beverages. Such ingredients include preservatives such as benzoic acid and salts thereof, sulfur dioxide, butylated hydroxyanisole, butylated hydroxytoluene, etc. Also, typically included are colors derived either from natural sources or synthetically prepared. Fungicides and microbial agents can also be included. Salt, e.g. sodium chloride, and other flavor enhancers can be used.

Emulsifiers can also be included. Any food grade emulsifier can be used. Lecithin is a preferred emulsifier including mono- and diglycerides of long chain fatty acids, preferably saturated fatty acids, and most preferably, stearic and palmitic acid mono- and diglycerides. Propylene glycol esters are also useful in beverage mixes.

Fats or oils can also be added to supplements to make them more palatable.

### Uses

Compositions of the present invention can be used to prepare calcium supplemented single strength beverages, candies and food compositions. An effective amount of the compositions, preferably in tablet or fine powder form, will produce a pleasant, refreshing effervescent beverage when deposited in water, juice, KOOL-AID®, or similar liquid medium. Milk can also be used.

When making a dry beverage powder mix or tablet, it is preferred to mix the calcium component, edible acid component with sugar or artificial sweeteners and flavors. Colors and color coated sugars can be added. A typical formula for beverage mixes is:

(a) flavorant, preferably from about 0.001% to about 5%;

(b) sweetener, preferably sucrose and more preferably colored sucrose, usually from about 0.001% to about 14%;

(c) a calcium component comprising from about 77% to about 100% of a primary calcium source which is calcium carbonate and from 0% to about 30% of a secondary calcium source (usually a calcium salt of an organic acid) selected from the group consisting of calcium acetate, calcium malate, calcium lactate and mixtures thereof; and

(d) an edible acid component comprising a mixture of citric acid and malic acid; wherein the percentage of citric acid to total acid(s) is at least 23%, preferably at least 25%, and not more than 75%, preferably not more than 70%, and the ratio of acid equivalents to base equivalents is from about 0.8 to about 1.8, preferably from about 1.0 to about 1.6 and most preferably from about 1.3 to about 1.5.

Calcium supplemented candies can be produced by adding lemon oil, or similar flavorant, to an effective amount of a fine-powdered composition of the present invention. Preferably this powder is encapsulated in a hard candy, gel or similar material. When consumed the candy will produce a pleasant popping sensation in the mouth.

### EXAMPLES

The following are specific embodiments of the supplement compositions and methods for making. These examples are illustrative of the invention and are not intended to be limiting of it.

### Example I

A calcium supplement is prepared as follows: 2.5 grams of calcium carbonate (1 g calcium), 1.5 grams of citric acid, and 2.9 grams of malic acid in the form of fine powders are dry blended. The mixture of powders is then tabletted by compression. This tablet is placed in 240 ml (8 ounces) of water and an effervescent reaction occurs to form CCM in situ. The beverage is clear and stable towards calcium precipitation for at least fourteen days at ambient temperatures.

### Example II

A calcium supplement is prepared as follows: 2.5 grams of calcium carbonate (1 g calcium), 2.7 grams of citric acid, and 1.7 grams of malic acid, in the form of fine powders, are dry blended. The mixture of powders is then tabletted by compression. This tablet is placed in 240 ml (8 ounces) of water and an effervescent reaction occurs to form CCN in situ. The beverage is clear and stable towards calcium precipitation for at least three days at ambient temperatures.

### Example III

| | Calcium | Calcium | | Citric | Malic | | | |
|---|---|---|---|---|---|---|---|---|
| | lactate | acetate | CaCO₃ | acid | acid | | Acid/ | Citric/ |
| Sample | (mg) | (mg) | (mg) | (mg) | (mg) | C:C:M¹ | Base² | acid³ |
| 1 | 0 | 0 | 2500 | 4352 | 0 | 0.42:1.81:0 | 1.36 | 100 |
| 2 | 0 | 0 | 2500 | 1599 | 2881 | 6:2:5 | 1.36 | 36 |
| 3 | 0 | 0 | 2500 | 1599 | 1675 | 6:2:3 | 1.00 | 49 |
| 4 | 0 | 0 | 2500 | 1126 | 3377 | 8.5:2:8.5 | 1.36 | 25 |
| 5 | 0 | 0 | 2500 | 444 | 1774 | 22:2:12 | 0.67 | 20 |
| 6 | 1539 | 0 | 2000 | 1599 | 1675 | 6:2:3 | 1.00 | 49 |
| 7 | 0 | 790 | 2000 | 1599 | 1675 | 6:2:3 | 1.00 | 49 |

¹C:C:M stands for moles of Calcium to moles of Citrate to moles of Malate.
²The weight ratio of acid equivalents to base equivalents. The weight ratio is calculated as given supra.
³The weight percentage of citric acid to total acid. The weight percentage is calculated as given supra.

For each sample, the calcium lactate, calcium acetate and/or calcium carbonate, in the form of fine powders, are dry blended with the citric acid and malic acid in the form of fine powders. The mixture of powders can then be tabletted by compression or packaged as a powder. Each tablet or powder is then placed in 240 ml (8 ounces) of water at 25° C. Each sample provides 1000 mg of calcium.

The calcium content of the aqueous phase is then determined by atomic absorption over time.

The Ca level is measured by atomic absorption using the following procedure:

Equipment

Perkin-Elmer Atomic Absorption Spectrophotometer Model 3030.

Stock Standard Solution

Calcium, 500 mg/L. To 1.249 g of primary standard calcium carbonate, CaCO₃, add 50 ml of deionized water. Add dropwise a minimum volume of 5% HCl (approximately 10 ml), to effect complete solution of the CaCO₃. Dilute to 1 liter with deionized water.

Light Sources

When using the calcium 239.9 nm line, the use of a multi-element (Ca—Mg) or (Ca—Mg—Al) hollow cathode lamp with a quartz window is recommended.

Flame Adjustment

The absorption of calcium is dependent on the fuel/air ratio and the height of the light beam above the burner. Although maximum sensitivity is obtained with a reducing (fuel-rich) flame, an oxidizing (fuel-lean) flame is recommended for optimum precision.

Other Flames

Calcium determination appears to be free from chemical interferences in the nitrous oxide-acetylene flame. Ionization interferences should be controlled by the addition of alkali salt (0.1% or more potassium as chloride) to samples and standards. It is probably preferable to determine calcium in a nitrous oxide-acetylene flame, especially in samples containing large amounts of silica.

Interferences

Slight ionization occurs in the air-acetylene flame, and can be controlled by the addition of an alkali salt (0.1% or more potassium as chloride) to samples and standards. Calcium sensitivity is reduced in the presence of elements which give rise to stable oxysalts. These elements include aluminum, beryllium, phosphorus, silicon, titanium, vanadium, and zirconium. This effect is reduced by the addition of 0.1-1.0% lanthanum or strontium.

Standard Atomic Absorption Conditions for Ca

| Wavelength | Slit Range | Sensitivity | Linear |
|---|---|---|---|
| (nm) | (nm) | (mg/L) | (mg/L) |
| 422.7 | 0.7 | 0.092 | 5.0 |
| 239.9 | 0.7 | 3.0 | 800.0 |

Recommended Flame

Air-acetylene, oxidizing (lean, blue). Sensitivity with a flow spoiler and N20-C2H2 flame at 422.7 nm: 0.048 mg/L.

Standard Flame Emission Conditions for Ca

| Wavelength | Slit | |
|---|---|---|
| (nm) | (nm) | Flame |
| 422.1 | 0.2 | Nitrous oxide-acetylene |

The calcium is determined by comparing the absorption with standard calcium solutions.

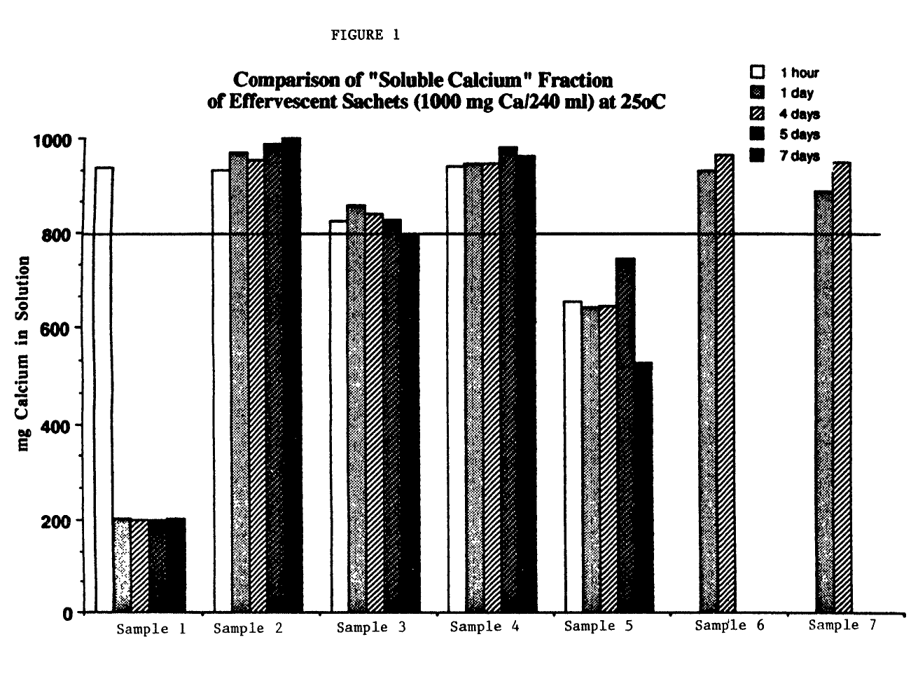

FIG. 1, a bar graph, illustrates the soluble calcium present in each of the seven prepared samples over time.

What is claimed is:

1. An effervescent calcium supplement comprising a unit dosage mixture of:
(a) a primary calcium source comprising calcium carbonate: and;
(b) an edible acid component comprising a mixture of citric acid and malic acid;
wherein the percentage of citric acid to total acid is at least 23% and not more than 75%; the weight ratio of acid equivalents to base equivalents is from 0.5 to 1.8; and at least 75% of the soluble calcium ion remains in solution for at least about 2 days.

2. A supplement according to claim 1 wherein the percentage of citric acid to total acid is at least 25% and not more than 70%.

3. A supplement according to claim 2 wherein the weight ratio of acid equivalents to base equivalents is from 1.0 to 1.6.

4. A supplement according to claim 2 further comprising a secondary calcium source selected from the group consisting of calcium malate, calcium acetate, calcium lactate and mixtures thereof wherein said secondary calcium source provides no more than about 30% of the soluble calcium ion.

5. A supplement according to claim 4 wherein the secondary calcium source provides for no more than about 23% by weight of the soluble calcium ion.

6. A supplement according to claim 3 wherein the weight ratio of acid equivalents to base equivalents is from 1.3 to 1.5.

7. A supplement according to claim 3 further comprising a sweetener.

8. A supplement according to claim 7 wherein the sweetener is sucrose.

9. A supplement according to claim 8 wherein the sucrose is colored sucrose.

10. A supplement according to claim 7 further comprising a flavorant.

11. A supplement according to claim 2 in the form of a powder.

12. A supplement according to claim 2 in the form of a tablet.

13. An effervescent beverage having stability from calcium precipitation for at least two days at 25° C. comprising the supplement of claim 2.

14. An effervescent beverage having stability from calcium precipitation for at least four days at 25° C. comprising the supplement of claim 8.
